(19) United States
(12) Patent Application Publication
(10) Pub. No.: US 2023/0391535 A1
(43) Pub. Date: Dec. 7, 2023

(54) Liquor Release Bottle Device

(71) Applicant: Leroy Wilkerson, Fort Worth, TX (US)

(72) Inventor: Leroy Wilkerson, Fort Worth, TX (US)

(21) Appl. No.: 17/832,008

(22) Filed: Jun. 3, 2022

(51) Int. Cl. B65D 81/32; A47J 31/44

(52) U.S. Cl. CPC B65D 81/3238; A47J 31/4407

(57) ABSTRACT

A liquor release bottle device for releasing liquor from a pouch into a bottle includes a bottle having a cylindrical shaped body. The bottle has a bottom end and a top end. The top end has a neck, and the neck has an opening. A cap is positioned on the opening of the bottle. The cap has a base, and the base has a perimeter wall. The perimeter wall extends downward towards the base. A pouch is coupled to the base of the cap. The pouch holds a liquor and releases the liquor into the interior of the bottle when the cap is removed from the bottle.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to liquid release device and more particularly pertains to a new liquid release device for releasing liquor from a pouch into a bottle.

### (2) Description of Related Art Including Information Disclosed Under 37 CFR 1.97 and 1.98

The prior art relates to liquid release devices. The prior art relates to variety of liquid release devices configured for releasing liquid into a drink container. Known prior art lacks a liquid release device configured for releasing liquor into a bottle from a pouch coupled to the cap of the bottle.

### (h) BRIEF SUMMARY OF THE INVENTION

An embodiment of the disclosure meets the needs presented above by generally comprising a bottle having a cylindrical shaped body. The bottle has a bottom end and a top end. The top end has a neck, and the neck has an opening. A cap is configured for being positioned on the opening of the bottle. The cap has a base, and the base has a perimeter wall. The perimeter wall protrudes downward relative to the base. A pouch is coupled to the base of the cap. The pouch is configured for holding a liquor and releasing the liquor into the interior of the bottle when the cap is removed from the bottle.

Furthermore, a method for releasing liquor into a mixture in a bottle includes the step of storing a liquor within a pouch within an interior of a bottle. The pouch is coupled to a cap, and the cap is positioned on an opening of the bottle. An aperture of the pouch is in a closed positioned between the cap and the bottle. The user twists the cap off of the bottle wherein releasing the aperture of the pouch. The liquor within the pouch is released into the interior of the bottle. The user sets aside the cap of the pouch and the pouch can be removed by pulling the pouch off of the cap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a liquor release bottle device according to an embodiment of the disclosure.

FIG. 2 is a front view of an embodiment of the disclosure of a step 1.

FIG. 3 is a front view of an embodiment of the disclosure of a step 2.

FIG. 4 is a front view of an embodiment of the disclosure of a step 3.

FIG. 5 is a cross-sectional view of an embodiment of the disclosure taken from FIG. 1 of Line 5-5.

### (j) DETAILED DESCRIPTION OF THE INVENTION

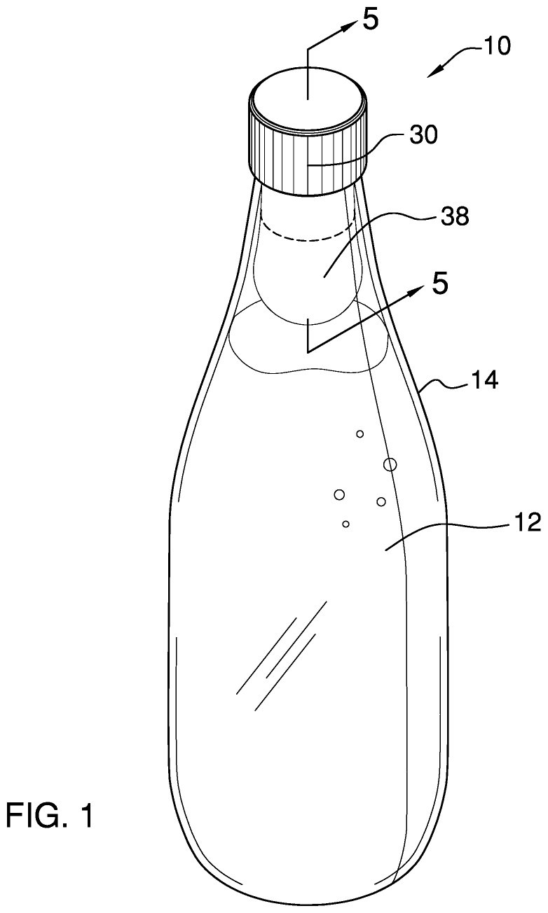

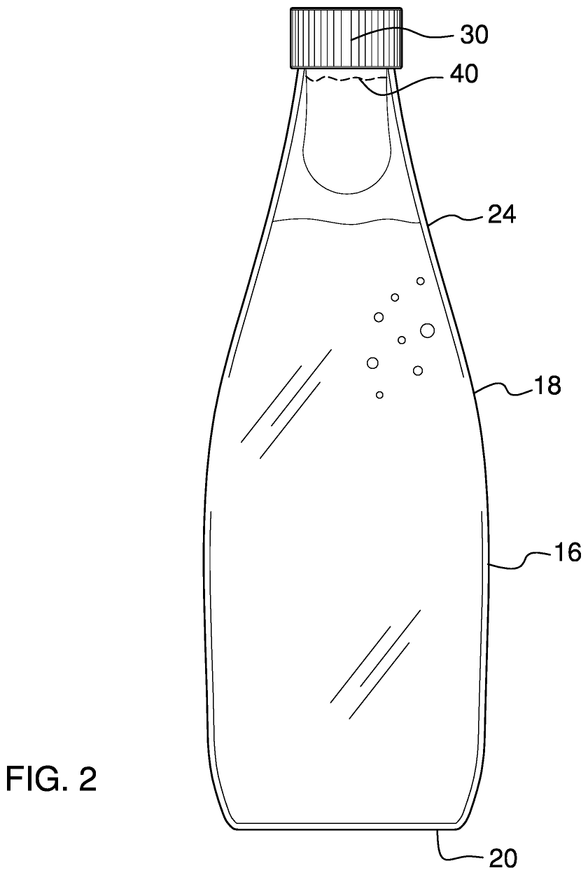

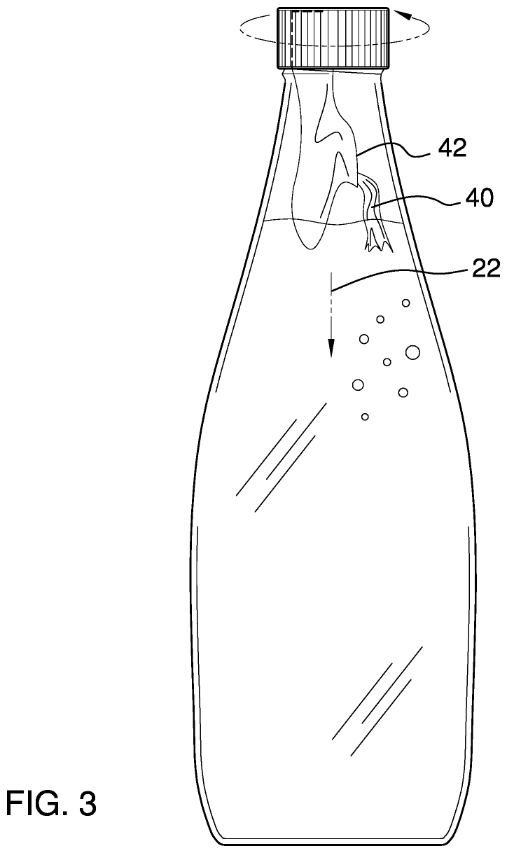

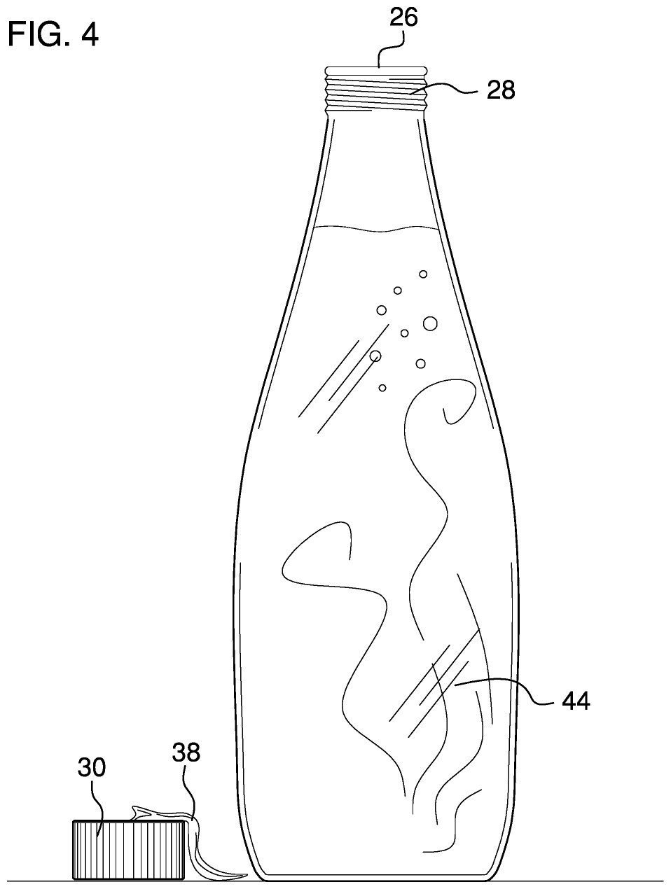

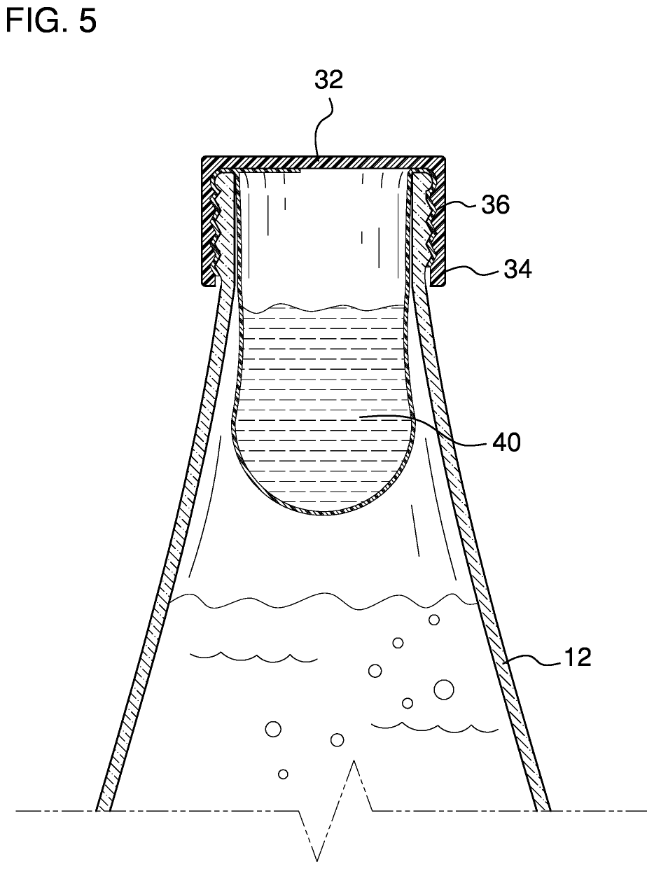

With reference now to the drawings, and in particular to FIGS. 1 through 5 thereof, a new liquid release device embodying the principles and concepts of an embodiment of the disclosure and generally designated by the reference numeral 10 will be described.

As best illustrated in FIGS. 1 through 5, the liquor release bottle device 10 generally comprises a bottle 12. The bottle 12 is configured for being a transparent material 14 wherein the user can see through the bottle 12. The bottle 12 has a cylindrical shaped body 16. The bottle 12 has a top end 18 and a bottom end 20. The bottom end 20 of the bottle 12 is flat and encloses an interior 22 of the bottle 12. The top end 18 of the bottle 12 has a neck 24 protruding upward from the cylindrical shaped body 16. The neck 24 is small-scaled relative to the cylindrical shaped body 16 of the bottle 12. Additionally, the neck 24 has an opening 26 being circular and configured for providing access to the interior 22 of the bottle 12. The opening 26 has an exterior surface 28, and the exterior surface 28 has threading.

A cap 30 is configured for being positioned on the opening 26 of the bottle 12. The cap 30 has a base 32 being circular with a perimeter wall 34. The perimeter wall 34 protrudes downward relative to the base 32 and has an interior surface 36. The interior surface 36 of the cap 30 has threading being complementary to the threading of the bottle 12. The cap 30 is configured for engaging by threading to the bottle 12. The cap 30 can be removed or attached to the bottle 12 by twisting the cap 30 relative to the bottle 12.

A pouch 38 is coupled to the base 32 of the cap 30. The pouch 38 is a plastic material and is configured for holding a liquor 40. The pouch 38 has an aperture 42 that is configured to release the liquor 40 into the interior 22 of the bottle 12. Prior to the release of the liquor 40, the aperture 42 of the pouch 38 is held in a closed position by being inserted between the interior surface 36 of the cap 30 to the exterior surface 28 of the bottle 12. The threading between the cap 30 and the bottle 12 restrains the pouch 38 from becoming undone. The liquor 40 within the pouch 38 is released into the interior 22 of the bottle 12 when the cap 30 is removed from the opening 26 of the bottle 12.

In use, the liquor 40 is stored within the pouch 38, and the pouch 38 is nested within the opening 26 of the neck 24 of the bottle 12. The aperture 42 of the pouch 38 is positioned on the exterior surface 36 of the opening 26 of the bottle 12, thus the pouch 38 secures to the bottle 12 as the cap 30 is fastened around the opening 26 of the bottle 12. The interior 22 of the bottle 12 can hold either beer or another beverage complementary to the liquor 40. When the cap 30 is twisted off the bottle 12, the aperture 42 of the pouch 38 falls downward towards the interior 22 of the bottle 12 to release the liquor 40. Subsequently, the pouch 38 can be removed from the cap 30 by pulling the pouch 38 off from the cap 30. The user can then enjoy the mixed beverage 44 within the interior 22 of the bottle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A release liquid mixing device configured for releasing liquor into a drink mixture within a bottle, the device comprising:
a bottle having a cylindrical shaped body, said bottle having a bottom end and a top end, said top end having a neck, said neck having an opening;
a cap being configured for being positioned on said opening of said bottle, said cap having a base, said base having a perimeter wall, said perimeter wall protruding downward relative to said base; and
a pouch being coupled to said base of said cap, said pouch being configured for holding a liquor, said pouch being configured for releasing said liquor into said interior of said bottle when said cap being removed from said bottle, said pouch having an aperture, said aperture being configured for being positioned between an interior surface of said cap and said exterior surface of said bottle, said aperture partially covering said opening in said neck when said pouch is positioned to extend into said bottle.

2. The release liquid mixing device of claim 1, further comprising said bottom end being flat and enclosing an interior of said bottle.

3. The release liquid mixing device of claim 1, further said neck protruding upward from said cylindrical shaped body, said neck being small-scaled relative to said cylindrical shaped body of said bottle.

4. The release liquid mixing device of claim 2, further comprising said opening being configured for providing access to said interior of said bottle.

5. The release liquid mixing device of claim 1, further comprising said opening having an exterior surface, said exterior surface having threading.

6. The release liquid mixing device of claim 1, further comprising said base being circular.

7. The release liquid mixing device of claim 5, further comprising said interior surface having threading.

8. The release liquid mixing device of claim 7, further comprising said threading of said cap being complementary to said threading of said bottle, said cap being configured for engaging by threading to said bottle.

9. The release liquid mixing device of claim 1, further comprising said pouch being a plastic material.

10. (canceled)

11. A release liquid mixing device configured for releasing liquor into a drink mixture within a bottle, the device comprising:
a bottle having a cylindrical shaped body, said bottle having a bottom end and a top end, said bottom end being flat and enclosing an interior of said bottle, said top end having a neck, said neck protruding upward from said cylindrical shaped body, said neck being small-scaled relative to said cylindrical shaped body of said bottle, said neck having an opening, said opening being configured for providing access to said interior of said. bottle, said opening having an exterior surface, said exterior surface having threading;
a cap being configured for being positioned on said opening of said bottle, said cap having a base, said base being circular, said base having a perimeter wall, said perimeter wall protruding downward relative to said base, said perimeter wall having an interior surface, said interior surface having threading, said threading of said cap being complementary to said threading of said bottle, said cap being configured for engaging by threading to said bottle; and
a pouch being coupled to said base of said cap, said pouch being a plastic material, said pouch being configured for holding a liquor, said pouch having an aperture, said aperture partially covering said opening in said neck when said pouch is positioned to extend into said bottle, said aperture being configured for being positioned between said interior surface of said cap and said exterior surface of said bottle, said pouch being configured for releasing said liquor into said interior of said bottle when said cap being removed from said bottle.

12. (canceled)
